(19) United States
(12) Patent Application Publication
(10) Pub. No.: US 2017/0294063 A1
(43) Pub. Date: Oct. 12, 2017

(54) ACCESS PREVENTION AND CONTROL FOR SECURITY SYSTEMS

(71) Applicant: GLOBAL TEL*LINK CORP., Reston, VA (US)

(72) Inventor: Stephen L. Hodge, Aubrey, TX (US)

(21) Appl. No.: 15/095,311

(22) Filed: Apr. 11, 2016

(51) Int. Cl. G07C 9/00; H04N 13/02; G08B 13/196; G06K 9/00; G06K 9/62; G06F 17/30; H04N 5/33

(52) U.S. Cl. CPC G07C 9/00158; G06F 17/3028; H04N 13/0203; H04N 5/33; G06K 9/00771; G06K 9/00288; G06K 9/6202; G08B 13/196

(57) ABSTRACT

A system is described herein that manages access to a secure housing facility. The system includes an illumination system configured to light an area surrounding the secure housing facility. A feature capture system configured to capture features of one or more individuals within the illumination area. The system stores information pertaining to unauthorized and authorized individuals in a database, where the information comprises facial images of the unauthorized and authorized individuals. The system uses a 3-D access module to compare the captured media to each of the facial images of the unauthorized and authorized individuals.

### BACKGROUND

### Field

The disclosure relates to a security system that monitors, controls, and prevents unauthorized individuals from accessing a managed access system.

### Background

In current prison facilities, inmates are permitted to communicate, using the prison's communication system, with a wide variety of individuals both inside and outside the prison facility. However, inmates and employees occasionally acquire contraband cellular devices to communicate unmonitored with individuals both inside and outside the prison facility for illegal activities. In order to prevent the use of the contraband cellular devices, managed access systems are often installed within prison facilities to block and restrict any calls made from the contraband cellular devices

### BRIEF DESCRIPTION OF THE DRAWINGS/FIGURES

Embodiments are described with reference to the accompanying drawings. In the drawings, like reference numbers indicate identical or functionally similar elements. Additionally, the left most digit(s) of a reference number identifies the drawing in which the reference number first appears.

FIG. 1 illustrates a block diagram of a security monitoring system, according to an example embodiment.

FIG. 2 illustrates another block diagram of a security monitoring system, according to an example embodiment.

FIG. 3 illustrates another block diagram of a security monitoring system, according to an example embodiment.

FIG. 4 illustrates a flowchart for monitoring individuals seeking access to a managed access system, according to an example embodiment.

FIG. 5 illustrates another flowchart for monitoring individuals seeking access to a managed access system, according to an example embodiment.

FIG. 6 illustrates another flowchart for monitoring individuals seeking access to a managed access system, according to an example embodiment.

FIG. 7 illustrates another flowchart for monitoring individuals seeking access to a managed access system, according to an example embodiment.

FIG. 8 depicts an example computer system useful for implementing various embodiments.

### DETAILED DESCRIPTION

The following Detailed Description refers to accompanying drawings to illustrate exemplary embodiments consistent with the disclosure. References in the Detailed Description to “one exemplary embodiment,” “an exemplary embodiment,” “an example exemplary embodiment,” etc., indicate that the exemplary embodiment described may include a particular feature, structure, or characteristic, but every exemplary embodiment may not necessarily include the particular feature, structure, or characteristic. Moreover, such phrases are not necessarily referring to the same exemplary embodiment. Further, when a particular feature, structure, or characteristic is described in connection with an exemplary embodiment, it is within the knowledge of those skilled in the relevant art(s) to affect such feature, structure, or characteristic in connection with other exemplary embodiments whether or not explicitly described.

The exemplary embodiments described herein are provided for illustrative purposes, and are not limiting. Other exemplary embodiments are possible, and modifications may be made to the exemplary embodiments within the spirit and scope of the disclosure. Therefore, the Detailed Description is not meant to limit the invention. Rather, the scope of the invention is defined only in accordance with the following claims and their equivalents.

Embodiments may be implemented in hardware (e.g., circuits), firmware, software, or any combination thereof. Embodiments may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical or other fonns of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact results from computing devices, processors, controllers, or other devices executing the firmware, software, routines, instructions, etc. Further, any of the implementation variations may be carried out by a general purpose computer, as described below.

For purposes of this discussion, any reference to the term “module” shall be understood to include at least one of software, firmware, and hardware (such as one or more circuit, microchip, or device, or any combination thereof), and any combination thereof. In addition, it will be understood that each module may include one, or more than one, component within an actual device, and each component that forms a part of the described module may function either cooperatively or independently of any other component forming a part of the module. Conversely, multiple modules described herein may represent a single component with an actual device. Further, components within a module may be in a single device or distributed among multiple devices in a wired or wireless manner.

The following Detailed Description of the exemplary embodiments will so fully reveal the general nature of the invention that others can, by applying knowledge of those skilled in relevant art(s), readily modify and/or adapt for various applications such exemplary embodiments, without undue experimentation, without departing from the spirit and scope of the disclosure. Therefore, such adaptations and modifications are intended to be within the meaning and plurality of equivalents of the exemplary embodiments based upon the teaching and guidance presented herein. It is to be understood that the phraseology or terminology herein is for the purpose of description and not of limitation, such that the terminology or phraseology of the present specification is to be interpreted by those skilled in relevant art(s) in light of the teachings herein.

Overview

American correctional facilities house prisoners in controlled environments run by supervisors, all over the country. In these correctional facilities, it is illegal for any individuals, prisoners and employees, to use a cellular device based on regulations of correctional jurisdictions. Regardless, there is an ongoing problem in correctional facilities that the prisoners and/or employees illegally receive and use cellular devices. In particular, employees such as prison staff and the prisoners can use the contraband cellular devices to coordinate an illegal activity that will go unmonitored. In addition, the individuals can benefit by making a profit on the use or sale of said contraband cellular devices. These issues cause a serious security concern with potentially fatal consequences.

Initially, correctional facilities tried solving this issue by installing a managed access system in a secure housing facility. The managed access system's function is to block or restrict any calls received or initiated by a cellular device used inside the correctional facility. In order to block or restrict any phone activity from the cellular device, the managed access system requires the use of expensive hardware and software. As a result, careful maintenance and updates to the expensive hardware and software is required to keep up with ever changing cell phone technology. This is because the prisoners and the prison staff can use various contraband cellular devices with various service providers. As a result, the managed access system must block or restrict every type of cellular device available to the prisoners and the prison staff.

However, prisoners, and sometimes prison staff, locate, access and damage this equipment, thereby rendering the managed access system inoperable. Normally, only cleared individuals gain entry to the secure housing facility through a locked door. The locked door is opened by request over an intercom system or unlocking a keyed lock. The prison staff has access to the intercom system and the prisoners can damage the keyed lock—both of which provide access into the secure housing facility. Therefore, by rendering the managed access system inoperable, the prisoners and the prison staff can continue to use their contraband cellular devices in correctional facilities. Not only does this perpetuate the significant security concerns, but it also adds substantial cost to the prison facility and/or jurisdiction.

As illustrated by the above examples, there are many unique concerns associated with individuals seeking to gain access to these secure housing facilities in order to damage the managed access system. To complicate matters, certain facilities outfit their inmates with personal inmate devices (PIDs)—personal devices, in the form of tablet computers, smartphones, etc. used for personal calls, digital content streaming, among other uses.

In light of the above, the present disclosure provides a system and method for monitoring, controlling, and preventing access to a secure housing facility. In different embodiments, the secure housing facility may greatly vary to include any area desired to be held secure from certain individuals. Such areas may include bank vaults, museum wings, an office space, apartment buildings, and chemistry labs, among others. However, for purposes of the following discussion, the disclosed system and method are used in a prison facility embodiment for protecting on-site managed access system equipment located in a secure housing facility. This consists of a system that provides automatic detection and recognition of individuals proximate to the secure housing facility, performs automatic logging of individuals seeking to gain access to the secure housing facility, alerts supervisors of unauthorized access to the secure housing facility, etc. By providing a system for automatically monitoring, controlling, and preventing access to the secure housing facility, significant burden is removed from supervisors monitoring the managed access system, while simultaneously ensuring all contraband cellular device activity remains blocked or restricted.

Exemplary Security Monitoring System

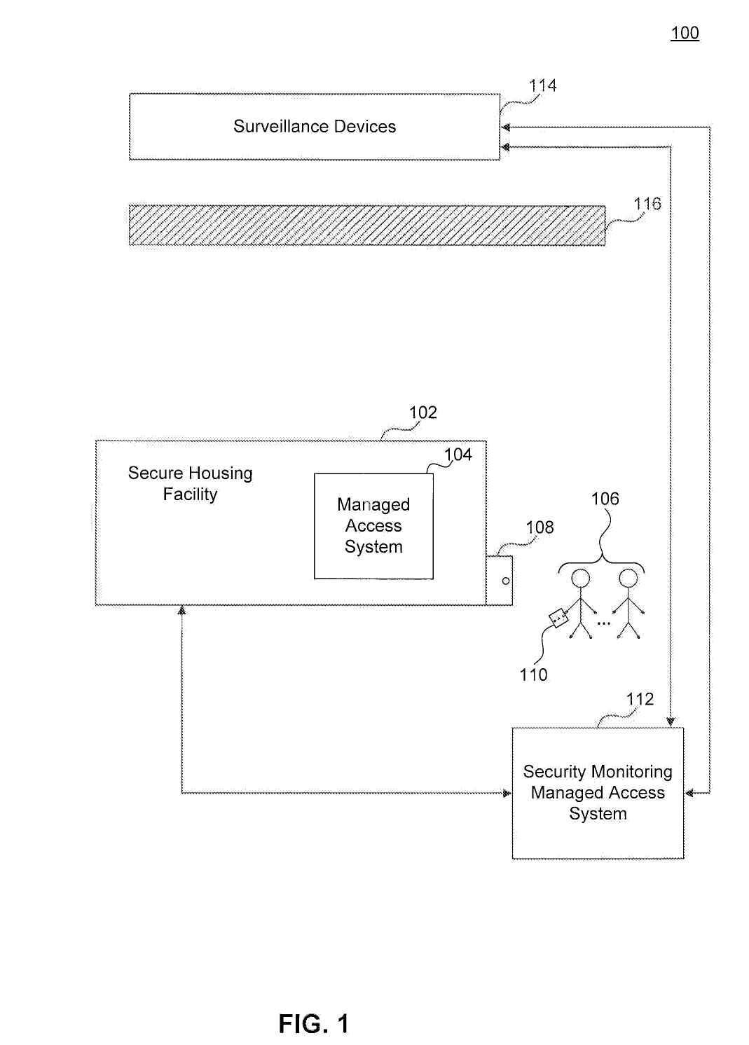

FIG. 1 illustrates a block diagram of a security monitoring system 100, according to an embodiment. The security monitoring system 100 includes a secure housing facility 102 configured to house and protect a managed access system 104 from one or more individuals 106 gaining access via secure housing facility door 108. The individuals 106 are unauthorized and/or authorized personnel, according to an embodiment. The personnel include prisoners, prison staff, and supervisors, to name a few examples. The managed access system 104 is configured to block or restrict cellular activity from any cellular device, such as cellular device 110, associated with any service provider in the security monitoring system 100, according to an embodiment. In an embodiment, cellular activity includes making/receiving phone calls, accessing the internet, and sending/receiving text messages, to name a few examples.

In an embodiment, the security monitoring system 100 includes a security monitoring managed access system 112 and surveillance devices 114. The security monitoring managed access system 112 is configured to monitor, control, and prevent access to secure housing facility 102. A more in depth explanation of the security monitoring managed access system 112 will be explained below. The surveillance devices 114 are configured to detect the presence of one or more individuals 106, according to an embodiment. Upon detection, the surveillance devices 114 capture media of the individuals 106 and transmit the captured media to security monitoring managed access system 112 for processing, according to an embodiment.

The security monitoring system 100 includes a protective screen 116, according to an embodiment. The protective screen 116 is configured to shield the surveillance devices 114 from susceptible attacks by the individuals 106. In an embodiment, the protective screen 116 is transparent, allowing the surveillance devices to see through the material of the protective screen 116, according to an embodiment. Examples of the protective screen 116 are a glass screen, netting, or a shade cloth. In an embodiment, the protective screen can be substituted with other obstruction devices, such as a metallic wall with a hole wide enough such that the surveillance devices 114 can view the secure housing facility 102 or a screened fence.

The surveillance devices 114 and protective screen 116 are set at a height out of reach of normal human height, according to an embodiment. For example, the surveillance devices 104 and protective screen 106 are set at a height above 15 or more feet in order to remain out of reach of the individuals 106.

The secure housing facility 102, the security monitoring managed access system 112, and the surveillance devices 114 are connected over bidirectional communication links, according to an embodiment. These communication links allow for simultaneous transmission in order to improve the timeliness of security monitoring system 100.

Exemplary Security Monitoring System

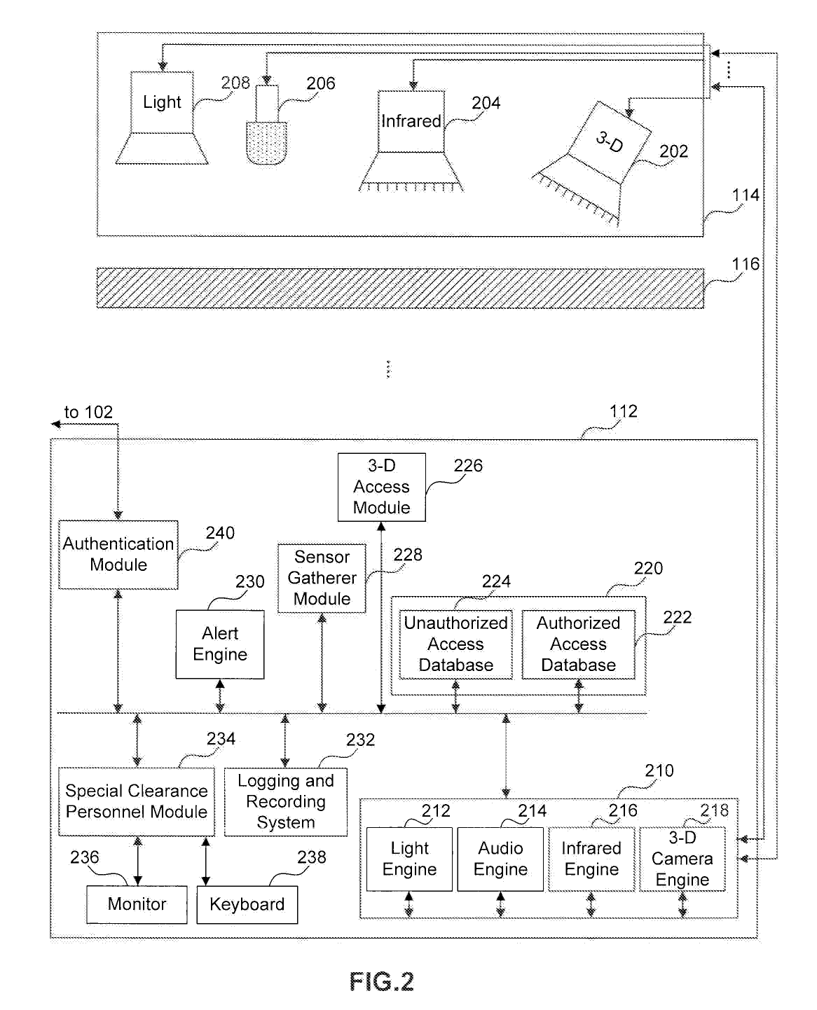

FIG. 2 illustrates another block diagram of a security monitoring system 100, according to an embodiment. FIG. 2 is similar to FIG. 1, but shows a detailed embodiment of the surveillance devices 114 and the security monitoring managed access system 112.

In particular, in the example of FIG. 2, the surveillance devices 114 include a 3-D camera 202, an infrared camera 204, a microphone 206, and an adjustable light 208, according to an embodiment. The security monitoring system 100 of FIG. 1 includes any or all of the surveillance devices 114. The security monitoring managed access system 112 includes a processing system 210. The processing system 210 includes a light engine 212, an audio engine 214, an infrared engine 216, and a 3-D camera engine 218, according to an embodiment. The security monitoring managed access system 112 also includes a database system 220, which includes an authorized access database 222 and an unauthorized access database 224. In addition, the security monitoring managed access system 112 includes a 3-D access module 226, a sensor gatherer module 228, an alert engine 230, a logging and recording system 232, a special clearance personnel module 234, a keyboard 236, a monitor 238, and an authentication module 240.

The 3-D camera 202 detects movement proximate to the secure housing facility door 108 of the secure housing facility 102, according to an embodiment. In an alternative embodiment, the surveillance devices 114 can include a motion sensor device (not shown in FIG. 2) to detect movement proximate to the secure housing facility door 108. The 3-D camera 202 detects movement by comparing pixel differences between captured subsequent frames, according to an embodiment. The 3-D camera 202 is configured to use DSP algorithms such as wavelet processing, neural networks, and hidden markov models, to name a few examples, to detect movement between captured subsequent frames. In an embodiment, the 3-D camera 202 captures media of one or more individuals 106 and transmits the media to the security monitoring managed access system 112. In an embodiment, the media is a still image or video. In an embodiment, the media includes 3-D properties such as depth perception in order to improve facial comparison algorithms.

Infrared camera 204 captures media using infrared radiation, according to an embodiment. The infrared camera 206 is configured to detect movement proximate to the secure housing facility door 108. The infrared camera 204 detects changes in infrared radiation, which varies as a function of temperature and surface characteristics of an object. For example, as one or more individuals 106 pass in front of the infrared camera 206, the infrared radiation will vary as the temperature at that point varies from room temperature to body temperature. This variation will result in a change in output voltage and if this change meets or exceeds a threshold, then the infrared camera 206 triggers detection.

Microphone 206 captures audio in an area surrounding the secure housing facility 102, according to an embodiment. The microphone 206 converts the captured audio to an electrical signal and transmits the electrical signal to the audio processor 214, according to an embodiment.

Adjustable light 208 is configured to dim or brighten an associated light bulb(s), according to an embodiment. The adjustable light 208 adjusts the brightness of the light bulb based on an adjustment signal sent from light processor 212.

As mentioned above, the processing system 210 houses a light engine 212, an audio engine 214, an infrared engine 216, and a 3-D camera engine 218, according to an embodiment. Particularly, the processing system 210 connects the individual engines (light engine 212, audio engine 214, infrared engine 216, and 3-D camera engine) to their associated surveillance devices 114, according to an embodiment. The connections between the individual processors and their associated surveillance devices 114 are bidirectional to facilitate rapid adjustments to the surveillance devices 114, according to an embodiment.

The light engine 212 communicates with the adjustable light 208, according to an embodiment. Specifically, the light engine 212 receives current status information associated with the brightness level of the adjustable light 208. In addition, the light engine 212 receives instructional information from the other individual engines. The instructional information includes instructions for the light engine 212 to brighten or dim the adjustable light 208 to a specified level, according to an embodiment. In an embodiment, the light engine 212 is configured to adjust the brightness of the adjustable light 208 if it receives instructional information with a different brightness level compared to the current status information.

The audio engine 214 communicates with microphone 206, according to an embodiment. Specifically, the audio engine 214 receives electrical signals from the microphone 206 denoting acoustic properties of captured sounds. The audio processor is configured to instruct the other individual engines, such as the infrared engine 216 and the 3-D camera engine 218, to capture media based on a threshold met by the acoustic properties, according to an embodiment. The audio engine 214 triggers the threshold if the acoustic properties reach above 5 decibels (dB), according to an embodiment. However, the threshold level is adjustable based on the normal audible level of the secure housing facility 102 without movement proximate to secure housing facility door 108, according to an embodiment.

The infrared engine 216 communicates with infrared camera 204, according to an embodiment. Specifically, the infrared engine 216 receives electrical characteristics from the infrared camera 204. The electrical characteristics are the voltages associated with the infrared detection. The infrared engine 216 is configured to trigger detection of movement should the voltage characteristic meet or exceed a threshold, according to an embodiment. In an embodiment, the threshold level is one volt. In an embodiment, the threshold level is adjustable based on the voltage level produced by a static environment surrounding the secure housing facility 102 without movement proximate to secure housing facility door 108, according to an embodiment. Further, the infrared engine 216 receives instructions from the audio engine 214 to capture media of an area around the secure housing facility door 108 of secure housing facility 102 if the infrared camera 204 did not detect movement, according to an embodiment. The media includes recorded video footage or recorded still images showing thermographic properties such as infrared radiation, according to an embodiment. The infrared engine 216 is configured to instruct the light engine 212 to adjust the brightness of the adjustable light 208, according to an embodiment. For example, the infrared engine 216 dims the brightness of the adjustable light 208 due to the brightness disrupting the ability of infrared camera 204 to detect movement via infrared radiation.

The 3-D camera engine 218 communicates with 3-D camera 202, according to an embodiment. Specifically, the 3-D camera engine 218 receives captured media from the 3-D camera 202, according to an embodiment. In an embodiment, the captured media is a still image or a recorded video with added depth perception. The 3-D camera engine 218 is configured to trigger detection of movement based on the number of pixel differences between captured subsequent frames in the media, according to an embodiment. In addition, the 3-D camera engine 218 is configured to instruct the 3-D camera 202 to adjust its settings. For example, the settings allow for zooming in, zooming out, panning left, panning right, panning up, panning down, and changing focus points in order to better identify the one or more individuals 103. In an embodiment, the 3-D camera engine 218 is configured to receive instructions from the audio engine 214 to capture media of an area around the door of secure housing facility 102 if the 3-D camera 202 did not detect movement, according to an embodiment. The 3-D camera engine 218 is also configured to provide the captured media to 3-D access module 226 for further processing which will be explained below. The 3-D camera engine 218 is configured to instruct the light processor 212 to adjust the brightness of the adjustable light 208, according to an embodiment. For example, the 3-D camera engine 218 is configured to dim the brightness of the adjustable light 208 due to the brightness disrupting the ability of 3-D camera 202 to detect movement via pixel changes.

Database system 220 includes an authorized access database 222 and an unauthorized access database 224, according to an embodiment. The databases 222 and 224 are located on one physical hardware device, according to an embodiment. In an alternative embodiment, the databases 222 and 224 are located on more than one physical hardware device. Further, the databases 222 and 224 are located on one or more virtual servers.

Authorized access database 222 stores information pertaining to individuals allowed entry into secure housing facility 102, according to an embodiment. The individuals allowed entry are the supervisors, a warden, and certain maintenance individuals, according to an embodiment. The information pertaining to individuals allowed entry includes a list of names associated with images of faces and associated 3-D characteristics or shapes of the individual's facial features. In an embodiment, the database stores the list of names with the associated images of the faces and the associated 3-D characteristics of the individual's facial features. The unauthorized access database 224 stores the same type of information in the same manner as authorized access database 222. Although, the unauthorized access database 224 stores information pertaining to individuals not allowed entry into security housing facility 102, according to an embodiment. In an embodiment, all individuals that are not expressly identified in the authorized access database 222 are considered to be unauthorized. However, in certain embodiments, it is beneficial to have a separate unauthorized access database 224. For example, individuals not identified in the authorized access database 222 and the unauthorized access database 224 are determined as unknown individuals. In an embodiment, a warden identifies these unknown individuals for special clearance access. The warden can then advise if the unknown individual is authorized or unauthorized to access the secure housing facility 102. Based on the warden's advisement, the special clearance personnel store the unknown individual's facial characteristics in either the authorized access database 222 or the unauthorized access database 224. The individuals not allowed entry are the prisoners, the prison staff, and some supervisors, according to an embodiment. Specifically, some supervisors are not allowed access because a possibility exists they are involved in the illegal sale and use of contraband cellular devices for their own profit.

The 3-D access module 226 is configured to receive captured media from the infrared engine 216 and the 3-D camera engine 218, according to an embodiment. Further, the 3-D access module 226 is configured to retrieve images of individuals and their associated 3-D characteristics from the authorized access database 222 and the unauthorized access database 224, according to an embodiment. The 3-D access module 226 is configured to perform facial comparisons between the received captured media and the images of individuals in the unauthorized access database 224 and authorized access database 222. In an embodiment, the 3-D access module 226 is configured to use facial recognition algorithms between the received captured media and the retrieved images of individuals from the database system 220 for comparison. In addition, the 3-D access module 226 is configured to use facial architecture recognition algorithm to compare the captured media received by 3-D camera 202 with 3-D characteristics of the individual's facial features. The captured media includes depth perception, which allows the facial architecture recognition algorithm to compare the captured media to the 3-D characteristics of the individual's facial features. Therefore, should the individual 106 in proximity to secure housing facility door 108 not face directly towards the 3-D camera 202, the facial architecture recognition algorithm is configured to determine the individual 106 based on the 3-D characteristics of the individual's head retrieved from the authorized access database 222 or the unauthorized access database 224, according to an embodiment.

Following the comparison using the 3-D access module 226, the results are compared to a threshold to determine if the individual 106 in the captured media matches an individual in one of the stored database systems 220, according to an embodiment. Following this comparison, the 3-D access module 226 is configured to notify the alert engine 230, the special clearance personnel module 234, the authentication module 240, and the logging and recording system 232, according to an embodiment.

The sensor gatherer module 228 is configured to receive output from each of the processing system 210 engines, according to an embodiment. Specifically, the sensor gatherer module 228 is configured to receive output from the engines and current settings regarding the adjustments of the surveillance devices 114. In an embodiment, the adjustments are the angle at which each of the surveillance devices 114 are pointed, their zoom distance, the brightness of adjustable light 208, the sensitivity of the microphone 206, and the various threshold detection levels, to name a few examples. Every time one of the processing system 210 engines adjusts the surveillance devices 114, the processing system 210 transmits the adjustments to the sensor gatherer module 228, according to an embodiment.

In an embodiment, the sensor gatherer module 228 is configured to store settings associated with the adjustments of the surveillance devices 114 in it. Further, the sensor gatherer module 228 receives a notification upon a triggered detection of movement by one of the surveillance devices 114, according to an embodiment. The sensor gatherer module 228 associates the notification of the triggered detection of movement with the adjustment settings, according to an embodiment. Later, a supervisor can view the adjustments associated with a detection of movement in the sensor gatherer module 228 to determine the optimum adjustments, according to an embodiment. Alternatively, the processing system 210 is configured to access the sensor gatherer module 228 and retrieve the last known adjustment settings associated with a detection of movement on a periodic basis to readjust the surveillance devices 114, according to an embodiment. In an embodiment, the processing system 210 is configured to access the sensor gatherer module 228 and retrieve the last known adjustment settings upon boot-up of security monitoring managed access system 112.

Alert engine 230 is configured to receive information pertaining to an alert from 3-D access module 226, according to an embodiment. In an embodiment, the information pertaining to the alert is a match resulting from a facial recognition comparison of an individual 106 to an individual in unauthorized access database 224; the facial recognition comparison resulting in a non-match; or, a timeout occurred during a readjustment of the surveillance devices 114. Upon receiving the information pertaining to the alerts, the alert engine 230 is configured to transmit a signal to special clearance personnel module 234 for alerting, according to an embodiment. Specifically, the alert engine 230 is configured to transmit an alert signal to a supervisor's personal digital assistant (PDA) (not shown in the figures), according to an embodiment. The alert engine 230 is configured to transmit the alert over Bluetooth, Wi-Fi, and the Internet, according to example embodiments.

Logging and recording system 232 includes a log file for recording purposes, according to an embodiment. The logging and recording system 232 logs all activities within the security monitoring managed access system 112, according to an embodiment. Specifically, the logging and recording system 232 logs the activities with an associated date and timestamp to denote when the activities took place, according to an embodiment. In an embodiment, the activities include adjusting the surveillance devices 114, receiving captured media from the surveillance devices 114, alerting security personnel, a match found or not found from the facial recognition processes, opening secure housing facility door 108 open, and the surveillance devices detecting movement, to name a few examples. Upon detection, the logging and recording system 232 will store a log entry along with associated captured media, according to an embodiment. This provides the supervisors a way to review the captured media to determine the individuals 106 proximate to the secure housing facility.

Special clearance personnel module 234 is one or more servers storing contact information for one or more supervisors, according to an embodiment. The contact information can include cell phone numbers, pager numbers, and email addresses, among others, according to example embodiments. The special clearance personnel module 234 includes a transmitter (not shown in FIG. 2). The special clearance personnel module 234 is configured to receive information from the alert engine 230 upon detection of an unauthorized individual seeking to gain entry to secure housing facility 102, according to an embodiment. In response, the special clearance personnel module 234 transmits a signal, using a transmitter, to the supervisors using their contact information to alert of the intrusion, according to an embodiment. By having the special clearance personnel module 234 alert the supervisors of intrusion, the supervisors can spend less time monitoring the secure housing facility 102 and more time monitoring the prisoners.

In an embodiment, the supervisors can monitor the secure housing facility 102 by viewing the monitor 236. The monitor 236 streams the viewing display of the 3-D camera 202, according to an embodiment. In an embodiment, the supervisors use an input device, such as the keyboard 238, to make adjustments to the surveillance devices 114. In addition, the secure housing facility 102 will allow the supervisors access into the unauthorized access database 224 and the authorized access database 22. The supervisors can access the database system 220 in order to modify, add, or delete information pertaining to individuals, such as prisoners, prison staff, and supervisors, according to an embodiment. As mentioned above, the information pertaining to individuals includes a list of names of the individuals associated with images of their face and 3-D characteristics of the individual's facial features. Further, the special clearance personnel module 234 allows supervisors to unlock, lock, and pop open secure housing facility door 108 using keyboard 238, according to an embodiment. Additionally, the special clearance personnel module 234 allows supervisors access into logging and recording system 232, according to an embodiment. The supervisors can access the logging and recording system 232 to view the log file and all of its contents. In an embodiment, the supervisors review the log file for specific activities of the security monitoring managed access system 112. Further, the supervisors can review any captured media associated with the activities in the log file to determine who entered the secure housing facility 102 and if any errors occurred with the security monitoring managed access system 112, according to example embodiments. In an embodiment, the errors include a mismatch result from the facial comparisons in the 3-D access module 226, a malfunction of any one of the components, and a malfunction of one of the surveillance devices 114.

Authentication module 240 is configured to receive an authentication signal or a non-authentication signal, according to an embodiment. The authentication module 240 is configured to receive an authentication signal or a non-authentication signal from the special clearance personnel module 234, the alert engine 230, and the 3-D access module 226, according to an embodiment. In response to receiving, the authentication module 240 will transmit a signal to the secure housing facility 102, according to an embodiment. Specifically, the signal will instruct the secure housing facility 102 to lock, unlock, or open secure housing facility door 108, according to an embodiment.

Exemplary Security Monitoring System

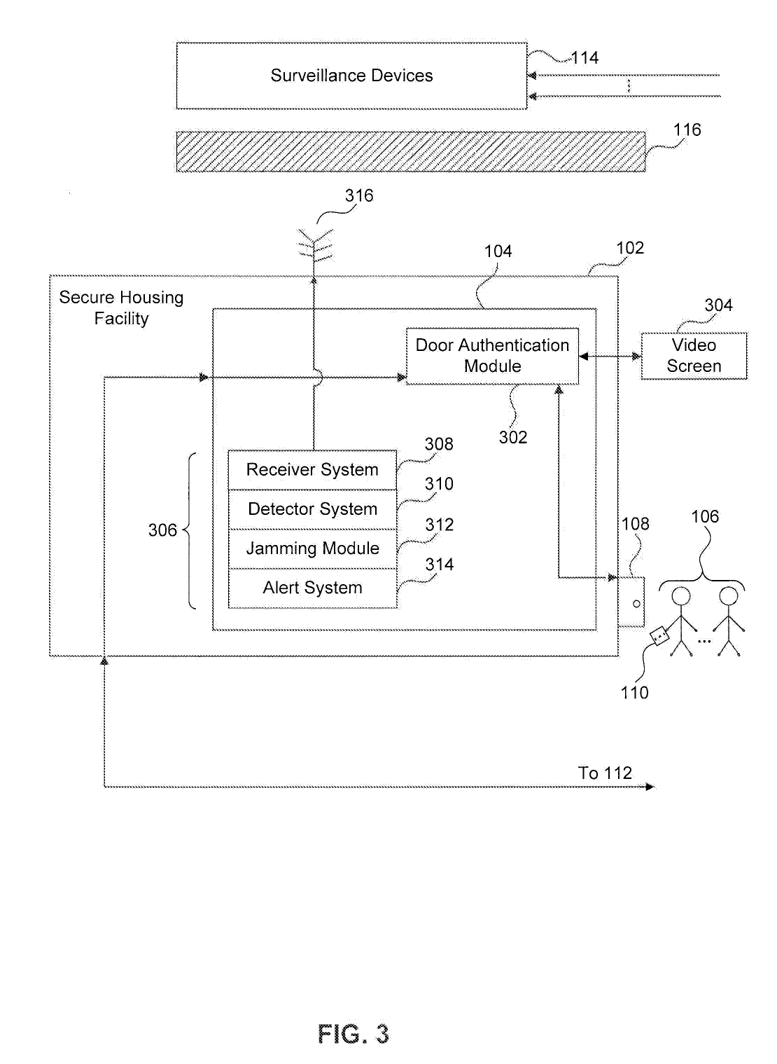

FIG. 3 illustrates another block diagram of a security monitoring system 100, according to an embodiment. FIG. 3 is similar to FIG. 1 and FIG. 2, but shows a detailed embodiment of the secure housing facility 102.

In particular, in the example of FIG. 3, the secure housing facility 102 includes a managed access system 104, which is explained in more detail. The managed access system 104 includes a door authentication module 302, a video screen 304, and a jammer system 306, according to an embodiment. The jammer system 306 includes a receiver system 308, a detector system 310, a jamming module 312, and an alert system 314, according to an embodiment. Further, the secure housing facility 102 includes an antenna 316.

The door authentication module 302 is configured to receive an authentication signal or a non-authentication signal from authentication module 240, according to an embodiment. In response to receiving from the authentication module 240, the door authentication module 302 will lock, unlock, or open secure housing facility door 108, according to an embodiment.

The video screen 304 is configured for individuals 106 seeking to gain access to secure housing facility 102. In an embodiment, a supervisor monitoring the special clearance personnel module 234 requests one of the individuals 106 to face the 3-D camera 202 such that the front of his or her face fits within the video screen 304. The 3-D camera 202 relays the captured media to the video screen 304 in real time, according to an embodiment. Once the supervisors verify the face of individual 106 fits within the video screen 304, the supervisor initiates the process of facial comparison using the 3-D access module 226 through special clearance personnel module 234, according to an embodiment.

In the jamming module 306 the receiver system 308 is configured to receive a spectrum of radio frequencies centered on the known frequency as designated by the supervisor using the antenna 316, according to an embodiment. For example, the supervisor instructs the receiver system 308 to scan 2.4 gigahertz, 2.8 gigahertz, and 3.0 gigahertz, according to an embodiment. In addition, the receiver system 308 is configured to receive spectrum centered on the known frequencies. For example, the receiver system 310 is configured to receive a spectrum using a bandwidth of 25 megahertz or 12.5 megahertz, according to an embodiment. The antenna 316 is configured to receive and transmit signals, according to an embodiment. In an alternative embodiment, the jamming module 306 automatically detects contraband cellular device activity by scanning radio frequencies across wide spectrums. For example, the module 306 scans across 1 gigahertz to 5 gigahertz searching for contraband cellular device activity. Upon detection, the jamming module 306 stores the detected frequency and blocks the signal energy on the detected frequency as explained below.

The detector system 310 is configured to process the received spectrum for contraband cellular device activities, according to an embodiment. Specifically, the detector system 310 processes the received spectrum and compares the received spectrum to a threshold level. If the power level of the received spectrum meets or exceeds the threshold level, then the detector system 310 transmits a signal to the jamming module 312 and the alert system 314, according to an embodiment. If the power level of the received spectrum does not meet the threshold level, the detector system 310 waits for the next received spectrum from the receiver system 308, according to an embodiment.

The jamming module 312 is configured to transmit a high-energy signal at the known detected frequency upon receiving a signal from the detector system 310 using antenna 316, according to an embodiment. Specifically, the jamming module 312 transmits the high-energy signal at the known detected frequency at a higher power than the received spectrum power to block or restrict the contraband cellular device activity with antenna 316. Further, the jamming module 312 transmits the high-energy signal at a wider bandwidth than the received spectrum in order to contain all contraband cellular device activity within the high-energy signal. These two factors ensure to efficiently block or restrict the contraband cellular device activity, according to an embodiment.

The alert system 314 is configured to transmit an alert signal to the supervisors upon receiving a signal from the detector system 314, according to an embodiment. Specifically, the alert system 314 transmits an alert signal to inform the supervisors that an individual inside secure monitoring system 100 is using a contraband cellular device 110, according to an embodiment. In an embodiment, the alert signal comprises information regarding the frequency the jamming module 306 detected and blocked the signal at, as well as, the time the detection occurred.

Surveillance Devices' Operations

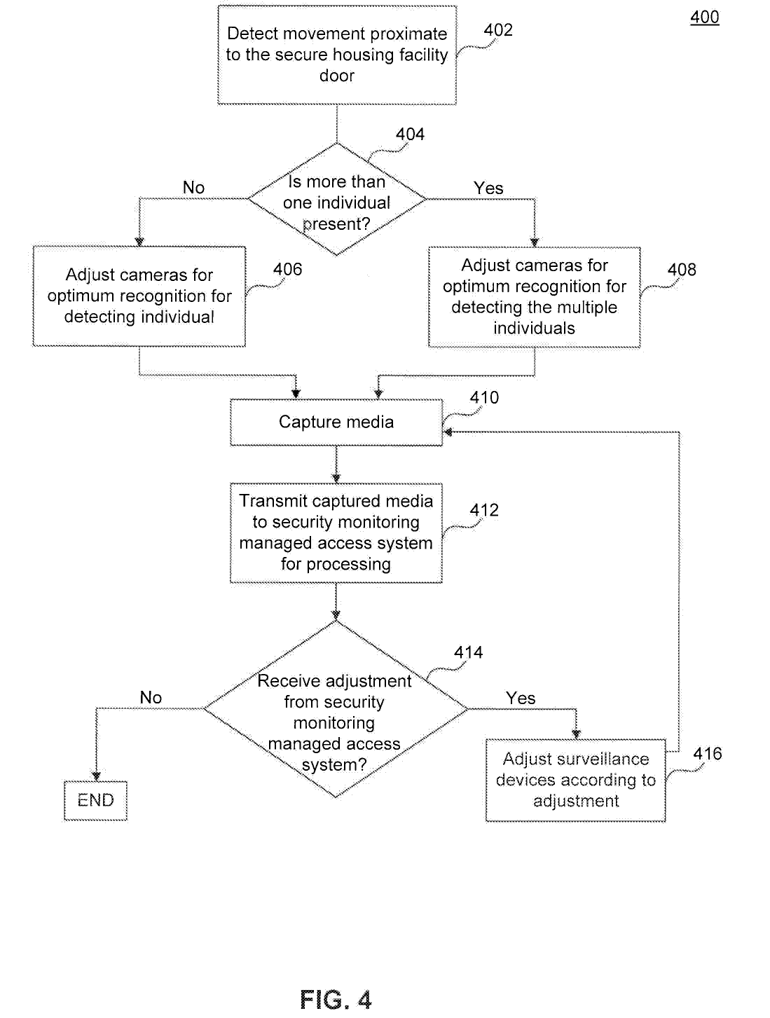

FIG. 4 is a method 400 for detecting and capturing media of individuals 106 using the surveillance devices 114, according to an embodiment. Method 400 can be performed using, for example, system 100 of FIGS. 1-3.

In step 402, the surveillance devices 114 detect movement proximate to the secure housing facility door 108. In particular, the 3-D camera 202 or the infrared camera 204 detects movement proximate to the secure housing facility door 108. As mentioned above, the 3-D camera 202 detects movement by comparing pixel differences between captured subsequent frames. The infrared camera 204 detects movement by detecting changes in infrared radiation.

In step 404, the surveillance devices 114 determines if more than one individual 106 is present proximate to the secure housing facility door 108. Specifically, the 3-D camera 202 determines if more than one individual is present by comparing the pixel differences to a given threshold. For example, if the pixel differences are wider than the pixel differences for one individual, then the 3-D camera 202 denotes more one individual is present.

The infrared camera 204 determines if more than one individual 106 is present by comparing the variation at which the temperature varies between the room temperature to body temperature to a given threshold. For example, if the variation is wider than a typical variation for one individual or the variation lasts for a longer period of time than the typical variation for one individual, then the infrared camera 204 denotes more than one individual is present.

If the 3-D camera 202 or the infrared camera 204 does not detect more than one individual present, then in step 406, those cameras adjust themselves for optimum recognition for detection of the one individual present. The two cameras adjust for optimum recognition by zooming in to view the one individual 106. Otherwise, in step 408, the cameras adjust themselves for optimum recognition detecting the multiple individuals 106. Specifically, the cameras zoom in such that the multiple individuals 106 fully encompass the view of the cameras.

In step 410, the cameras, 3-D camera 202 and the infrared camera 204, capture media of the one or more individuals 106. The cameras are configured to capture a video for a predetermined length or an image.

In step 412, the cameras transmit their respective captured media to security monitoring managed access system 112 for processing.

In step 414, the surveillance devices 114 verify if adjustments are received from the security monitoring managed access system 112. If the surveillance devices 114 do not receive any adjustments, method 400 ends. Alternatively, if the surveillance devices 114 receive adjustments, then in step 416, the surveillance devices 114 adjust their current settings based on the received adjustments. As mentioned above, the adjustments include changing the angle at which each of the surveillance devices 114 are pointed, their zoom distance, the brightness of adjustable light 208, the sensitivity of the microphone 206, and the various threshold detection levels for the 3-D camera 202 and the infrared camera 204, to name a few examples. Following the surveillance devices 114 adjusting their current settings based on the adjustments, method 400 proceeds to step 410.

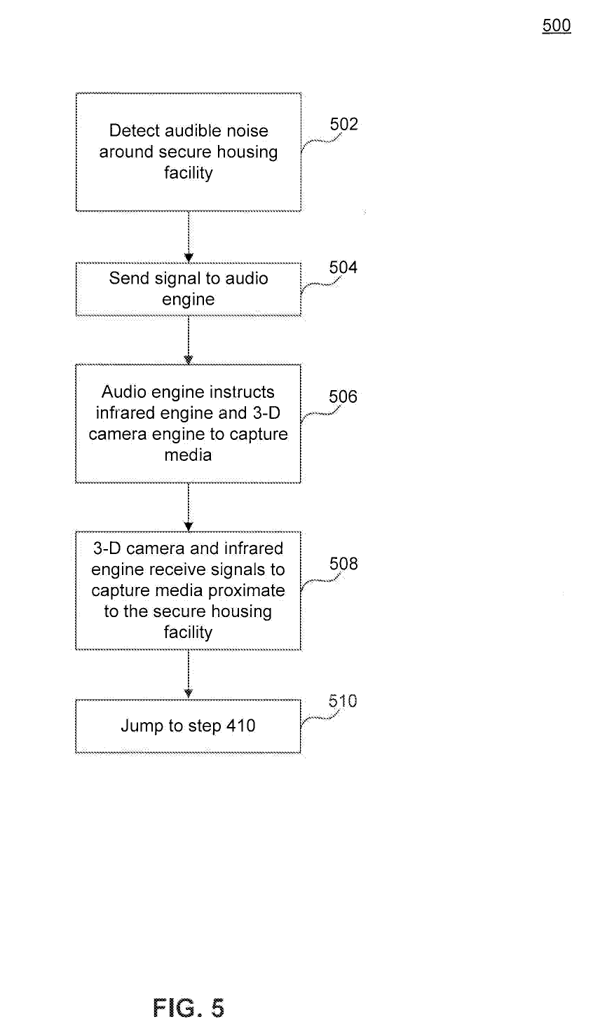

FIG. 5 is another method 500 for detecting and capturing media of individuals 106 using the surveillance devices 114, according to an embodiment. Method 500 can be performed using, for example, system 100 of FIGS. 1-3.

In step 502, the microphone 206 detects audible noise around secure housing facility 102. The microphone 206 is configured to compare the audible noise to a threshold level. Should the audible noise exceed or meet the threshold level, such as 5 dB, then in step 504, the microphone 206 transmits the audible noise to the security monitoring managed access system 112. The microphone 206 transmits the audible noise to the audio engine 214 in the processing system 210.

In step 506, upon receipt of the audible noise, the audio engine 214 transmits a signal to the 3-D camera engine 218 and the infrared engine 216. Specifically, the signal instructs the 3-D camera engine 218 and the infrared engine 216 to instruct their respective surveillance devices 114 to capture media proximate to the secure housing facility door 108. In case the 3-D camera 202 and the infrared camera 204 misses the individuals 106 movement due to some anomaly, the microphone 206 can assist in detecting individuals 106. For example, the individuals 106 create an anomaly such as a smoke screen or some other distraction in which the 3-D camera 202 cannot detect pixel differences in its subsequent images or the infrared camera 202 cannot identify heat signatures, causing detection issues. However, using the microphone 206, the cameras can still capture media.

In step 508, the 3-D camera 202 and the infrared camera 204 receive instructions from their respective engines (3-D camera engine 218 and infrared engine 216) to capture media proximate to the secure housing facility door 108. In step 510, method 500 jumps to step 410 in FIG. 4 to capture media.

Security Monitoring Managed Access System 112 Operations

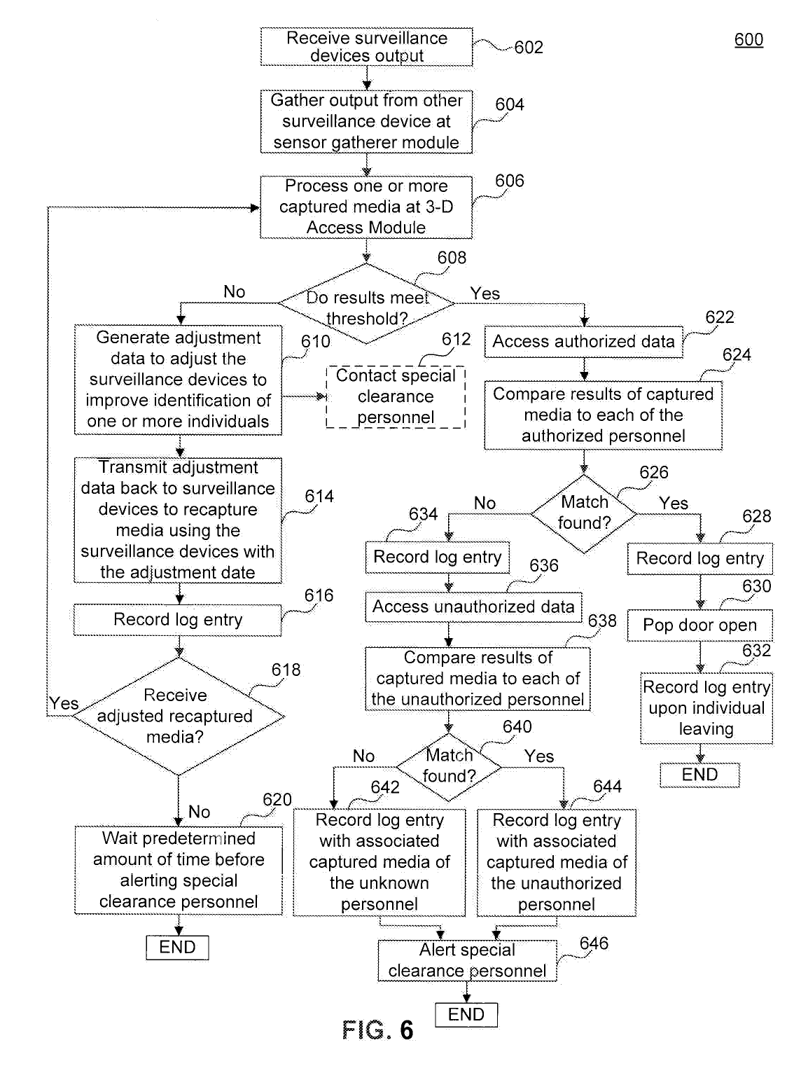

FIG. 6 is a method 600 for processing received captured media of individuals 106 using the security monitoring managed access system 112, according to an embodiment. Method 600 can be performed using, for example, system 100 of FIGS. 1-3.

In step 602, the security monitoring managed access system 112 receives output from surveillance devices 114. Accordingly, the light engine 212 receives the settings associated with the adjustable light 208, the audio engine 214 receives audible noise from the microphone 206, the infrared engine 216 receives electrical characteristics from the infrared camera 204, and the 3-D camera engine 218 receives captured media from the 3-D camera 202.

In step 604, each of the engines in the processing system 220 transmit their received output to the sensor gatherer module 228 for fast access. As mentioned above, the sensor gatherer module 228 is configured to receive and store the outputs from each of the processing system 210 engines, current settings of the surveillance devices 114, and any adjustments made to the surveillance devices 114.

In step 606, the sensor gatherer module 228 transmits the captured media to the 3-D access module 226. Initially, the 3-D access module 226 is configured to process the captured media to determine if a face or a head exists that is sufficient for comparing to authorized or unauthorized images of faces or heads. Specifically, the 3-D access module 226 determines this by scanning the captured media for typical facial characteristics of humans, such as noses, eyes, mouth, according to a few examples.

In step 608, the 3-D access module 226 determines if the number of typical facial features found in the captured media meet a certain threshold. The threshold requires the captured media to have at least three facial features found such as eyes, nose, and mouth. In an alternative embodiment, the threshold for the number of facial features is adjustable based on a desired accuracy of the facial recognition algorithms. If the results do not exceed or meet the threshold, then in step 610, the 3-D access module 226 generates adjustment data to adjust the surveillance devices 114 to improve identification of the one or more individuals 106. Specifically, the 3-D access module 226 accesses the sensor gatherer module 228 and determines if the adjustable light 208 needs to be brightened based on its current settings. Further, the 3-D access module 226 is configured to zoom in or zoom out the 3-D camera 202 depending upon its current settings.

In optional step 612, the 3-D access module 226 is configured to contact special personnel such as supervisors, regarding an ongoing process to identify possible individuals 106 in captured media. The special personnel individuals access the special clearance personnel module 234 using the monitor 236 and keyboard 238 in order to assist in processing the captured media.

In step 614, the 3-D access module 226 instructs the sensor gatherer module 228 to transmit adjustment data to the surveillance devices 114. The 3-D access module 226 instructs the sensor gatherer module 228 to adjust the surveillance devices 114 current settings in its storage, store those adjustment settings in the sensor gatherer module 228, and transmit the adjustment settings to the processing system 210. The respective engines in the processing system 210 will transmit the adjustment settings to their respective surveillance devices 114.

In step 616, the 3-D access module 226 will record an entry in the logging and recording system 232 noting of an adjustment. Specifically, the logging and recording system 232 will write the log entry to the log file with an associated date and timestamp to denote when the adjustments occurred. Further, the log entry will include the associated captured media, which warranted the need for 3-D access module 226 to adjust.

In step 618, the 3-D access module 226 waits for the adjusted recaptured media. The 3-D access module 226 polls the sensor gatherer module 228 to determine if it has received the adjusted recaptured media. If the sensor gatherer module 228 has not yet received the adjusted recaptured media, then in step 620, the 3-D access module 226 waits a predetermined amount of time before alerting special clearance personnel, such as supervisors. In an embodiment, the predetermined amount of time is 5 seconds. In an alternative embodiment, this predetermined amount of time is adjustable dependent upon the length of time the surveillance devices 114 take to capture media and transmit the captured media to security monitoring managed access system 112 during normal operation. Alternatively, if the 3-D access module 226 determines the sensor gatherer module 228 received the recaptured adjusted media, then the process proceeds to step 606 for processing.

In step 608, if the typical facial features found in the captured media do meet the threshold, then in step 622, the 3-D access module 226 accesses the authorized access database 222. The 3-D access module 225 accesses the authorized access database 222 to retrieve information pertaining to individuals allowed entry into secure housing facility 102. As mention above, the information pertaining to individuals allowed entry includes a list of names associated with images of faces of the individuals and 3-D characteristics of the individuals' head.

In step 624, the 3-D access module 226 performs facial comparisons of the received captured media to each of the images of the individuals in the authorized access database 222. These comparisons are performed using facial recognition algorithms. In addition, facial architecture recognition algorithms are performed to compare the received captured media, with the depth perception, to the 3-D characteristics of the individuals' head.

In step 626, the 3-D access module 226 determines if a match occurred between the individuals 106 in the received captured media to an authorized individual in the authorized access database 222. If the 3-D access module 226 determined a match, then in step 628, a log entry is recorded. Log entry in step 628 is similar to log entry in step 616 with the addition of the results of the facial comparisons. Further, the log entry in step 628 records the opening of the secure housing facility door 108.

In step 630, the 3-D access module 226 transmits a signal to the authentication module 240 with instructions to open the secure housing facility door 108. As a result, the authentication module 240 will then transmit a signal to the door authentication module 302 with instructions to open the secure housing facility door 108.

In step 632, the 3-D access module 226 records a log entry in the logging and recording system 232 upon the authorized individuals 106 leaving the secure housing facility 102. The door authentication module 302 transmits a signal to the authentication module 240 upon an individual 106 opening the secure housing facility door 108 from the inside and the door closing. Should the secure housing facility door 108 remain open longer than a predetermined amount of time, the door authentication module 203 will transmit an alert signal to alert engine 230 via authentication module 240. In an embodiment, the predetermined amount of time is 2 seconds. In an alternative embodiment, the predetermined amount of time is adjusted based on the amount of time it takes one individual to open, enter, and close the secure housing facility door 108. The alert engine 230 alerts special clearance personnel of an individual 106 who is allowing other individuals into the secure housing facility 102.

If no match occurred in step 626, then in step 634, the 3-D access module 226 records a log entry. Step 634 is similar to step 616 with the addition that no match occurred when utilizing the authorized access database 222.

In step 636, the 3-D access module 226 access the unauthorized access database 224 to retrieve information pertaining to individuals not allowed entry into secure housing facility 102. As mention above, the information pertaining to individuals not allowed entry includes a list of names associated with images of faces of the individual and 3-D characteristics of the individual's facial features. The individuals not allowed entry are prisoners and prison staff.

In step 638, the 3-D access module 226 performs facial comparisons of the received captured media to each of the images of the individuals in the unauthorized access database 224. The 3-D access module 226 performs these comparisons using facial recognition algorithms. Further, facial architecture recognition algorithms are performed to compare the received captured media, with the depth perception, to the 3-D characteristics of the individual's facial features.

In step 640, the 3-D access module 226 determines if a match occurred between the individuals 106 in the received captured media to an unauthorized individual in the unauthorized access database 224. If the 3-D access module 226 did not determine a match, then in step 642, a log entry is recorded with the captured media of the unknown personnel. Log entry is similar to log entry in step 616 with the addition of the results of the facial comparisons. Further, the log entry in step 642 records that an unknown individual is seeking to gain entry into the secure housing facility 102.

Alternatively, if the 3-D access module 226 determines a match in step 640, then in step 644, a log entry is recorded with the captured media of the unauthorized personnel.

In step 646, the 3-D access module 226 alerts the special clearance personnel via the special clearance personnel module 234. The 3-D access module 226 transmits a signal to the special clearance personnel module 234 for notifying supervisors of unauthorized intrusion.

Special Clearance Personnel Operations

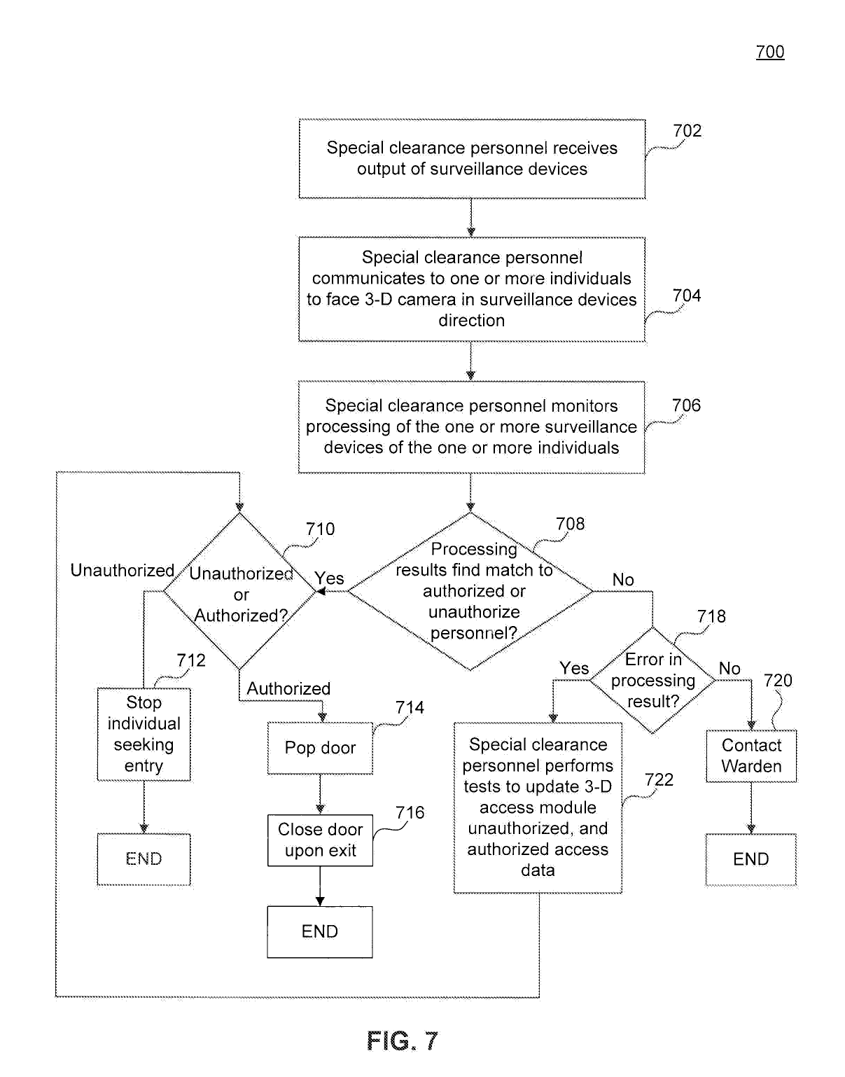

FIG. 7 is another method 700 for processing received captured media of individuals 106 using the security monitoring managed access system 112, according to an embodiment. Method 700 can be performed using, for example, system 100 of FIGS. 1-3.

In particular, method 700 results from optional step 612. In step 702, the special clearance personnel receive the output of the surveillance devices from sensor gatherer module 228. The special clearance personnel receive the output of the surveillance devices from the sensor gatherer module 228 at the special clearance personnel module 234 using the monitor 236. The keyboard 238 allows the user to interact with the outputs on special clearance personnel module 234.

In step 704, the special clearance personnel communicate to the individuals 106 to face the 3-D camera 202 such that their face is fully displayed on the video screen 304. The special clearance personnel speak into a microphone of the special clearance personnel module 234. The special clearance personnel module 234 will transmit the audio to speakers (not shown in FIGS. 1-3) in order for the individuals 106 to hear the special clearance personnel's voice. In addition, the special clearance personnel adjusts the surveillance devices 114 to ensure the face of individual 106 fits within the video screen 304. For example, the special clearance personnel adjusts the brightness of light of adjustable light 208, zoom in/zoom out the 3-D camera 202, or zoom in/zoom out the infrared camera 204.

In step 706, the special clearance personnel will instruct the surveillance devices 114 to capture media of the individuals 106 once their faces are within the video screen 304. Once the media is captured, the special clearance personnel will initiate the facial comparison process utilizing the 3-D access module 226. Specifically, once the sensor gatherer module 228 receives the captured media, the special clearance personnel will instruct the 3-D access module 226 to perform facial comparisons between the received captured media and the information pertaining to individuals in the authorized access database 222 and the unauthorized access database 224.

In step 708, the 3-D access module 226 reports the results of the facial comparisons to the special clearance personnel module 234. The results are reported to the special clearance personnel module 234 in order for the special clearance personnel to act on the results. If the 3-D access module 226 reports a match, then in step 710, the 3-D access module 226 provides whether the match occurred with an individual from the authorized access database 222 or from the unauthorized access database 224.

If step 710 results in a match to an individual in the unauthorized access database 224, then in step 712, the special clearance personnel move to stop the unauthorized individual seeking entry into the secure housing facility 102. Alternatively, if individual 106 matches to an individual in the authorized access database, then in step 714, the special clearance personnel unlock and pop open the secure housing facility door 108.

In step 716, the special clearance personnel ensure the secure housing facility door 108 closes upon the authorized individual's leaving. The special clearance personnel ensure the secure housing facility door 108 closes by locking the door after the authorized individual leaves.

If a match occurred in step 708, then in step 718, the special clearance personnel determines if an error occurred in the facial comparison. The special clearance personnel will visually inspect the individuals in the received captured media at the special clearance personnel module 234 via the monitor 236. In particular, the special clearance personnel determine if the individual in the captured media should have detected based on the comparisons by the 3-D access module 226. If after visual inspection, the special clearance personnel determines no error occurred in processing (the individual 106 is unknown), then in step 720, the special clearance personnel will contact the warden to determine the next steps to take.

If the special clearance personnel determined an error occurred in step 718, then in step 722, the special clearance personnel performs procedures to update the 3-D access module 226, unauthorized access database 224, and authorized access database 222. These procedures include recapturing an image of the individual's face that should have been recognized by the facial comparison. In addition, the procedures include recapturing a 3-D image of the individual's head. In an embodiment, the recaptured individual's face and the 3-D image of the individual's head are stored in the authorized access database, along with the previous image of the individual. This allows the facial recognition algorithm and the facial architecture recognition algorithm to finely tune the results of the facial comparisons.

Following the storing of the recaptured images, the special clearance personnel re-performs the facial comparisons to ensure the newly captured images, including the 3-D image, result in a match with the current captured media of the individual seeking access. The process will continue until a match occurs. Afterward, the process proceeds to step 710, to determine if a match exists to an individual in the authorized access database 222 or in the unauthorized access database 224.

Exemplary Computer System Implementation

It will be apparent to persons skilled in the relevant art(s) that various elements and features of the present disclosure, as described herein, can be implemented in hardware using analog and/or digital circuits, in software, through the execution of computer instructions by one or more general purpose or special-purpose processors, or as a combination of hardware and software.

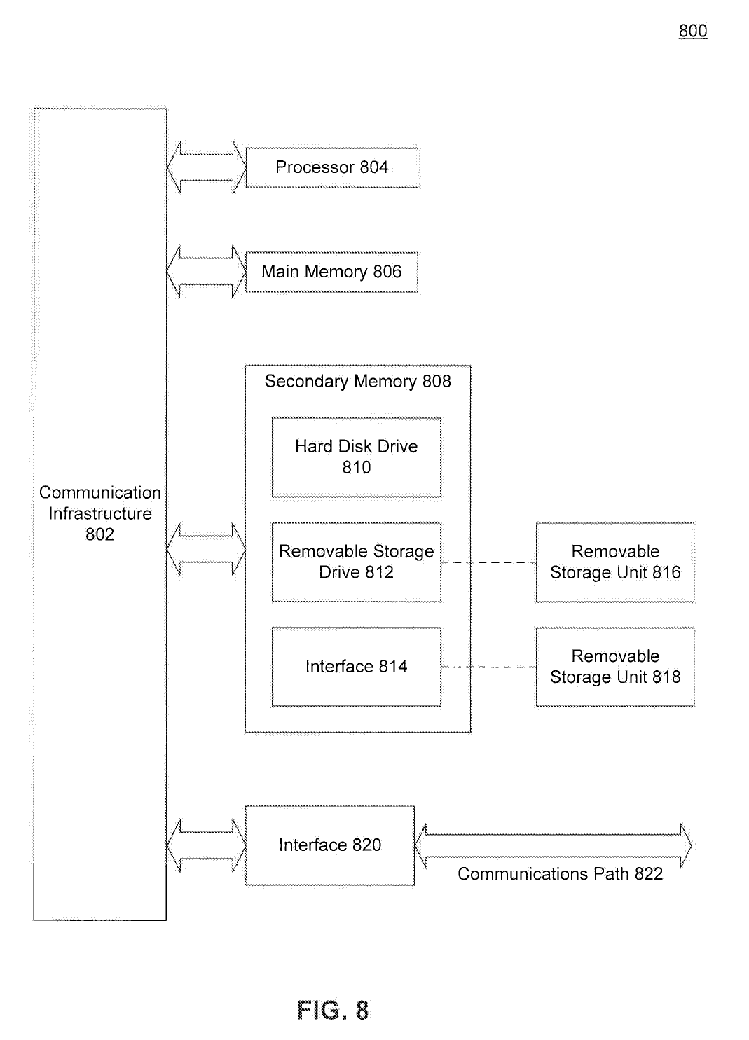

The following description of a general purpose computer system is provided for the sake of completeness. Embodiments of the present disclosure can be implemented in hardware, or as a combination of software and hardware. Consequently, embodiments of the disclosure may be implemented in the environment of a computer system or other processing system. For example, the method of flowcharts 400, 500, 600, and 700 can be implemented in the environment of one or more computer systems or other processing systems. An example of such a computer system 800 is shown in FIG. 8. One or more of the modules depicted in the previous figures can be at least partially implemented on one or more distinct computer systems 800.

Computer system 800 includes one or more processors, such as processor 804. Processor 804 can be a special purpose or a general purpose digital signal processor. Processor 804 is connected to a communication infrastructure 802 (for example, a bus or network). Various software implementations are described in terms of this exemplary computer system. After reading this description, it will become apparent to a person skilled in the relevant art(s) how to implement the disclosure using other computer systems and/or computer architectures.

Computer system 800 also includes a main memory 806, preferably random access memory (RAM), and may also include a secondary memory 808. Secondary memory 808 may include, for example, a hard disk drive 810 and/or a removable storage drive 812, representing a floppy disk drive, a magnetic tape drive, an optical disk drive, or the like. Removable storage drive 812 reads from and/or writes to a removable storage unit 816 in a well-known manner. Removable storage unit 816 represents a floppy disk, magnetic tape, optical disk, or the like, which is read by and written to by removable storage drive 812. As will be appreciated by persons skilled in the relevant art(s), removable storage unit 816 includes a computer usable storage medium having stored therein computer software and/or data.

In alternative implementations, secondary memory 808 may include other similar means for allowing computer programs or other instructions to be loaded into computer system 800. Such means may include, for example, a removable storage unit 818 and an interface 814. Examples of such means may include a program cartridge and cartridge interface (such as that found in video game devices), a removable memory chip (such as an EPROM, or PROM) and associated socket, a thumb drive and USB port, and other removable storage units 818 and interfaces 814 which allow software and data to be transferred from removable storage unit 818 to computer system 800.

Computer system 800 may also include a communications interface 820. Communications interface 820 allows software and data to be transferred between computer system 800 and external devices. Examples of communications interface 820 may include a modem, a network interface (such as an Ethernet card), a communications port, a PCMCIA slot and card, etc. Software and data transferred via communications interface 820 are in the form of signals, which may be electronic, electromagnetic, optical, or other signals capable of being received by communications interface 820. These signals are provided to communications interface 820 via a communications path 822. Communications path 822 carries signals and may be implemented using wire or cable, fiber optics, a phone line, a cellular phone link, an RF link and other communications channels.

As used herein, the terms “computer program medium” and “computer readable medium” are used to generally refer to tangible storage media such as removable storage units 816 and 818 or a hard disk installed in hard disk drive 810. These computer program products are means for providing software to computer system 800.

Computer programs (also called computer control logic) are stored in main memory 806 and/or secondary memory 808. Computer programs may also be received via communications interface 820. Such computer programs, when executed, enable the computer system 800 to implement the present disclosure as discussed herein. In particular, the computer programs, when executed, enable processor 804 to implement the processes of the present disclosure, such as any of the methods described herein. Accordingly, such computer programs represent controllers of the computer system 800. Where the disclosure is implemented using software, the software may be stored in a computer program product and loaded into computer system 800 using removable storage drive 812, interface 814, or communications interface 820.

In another embodiment, features of the disclosure are implemented primarily in hardware using, for example, hardware components such as application-specific integrated circuits (ASICs) and gate arrays. Implementation of a hardware state machine so as to perform the functions described herein will also be apparent to persons skilled in the relevant art(s).

### CONCLUSION

The disclosure has been described above with the aid of functional building blocks illustrating the implementation of specified functions and relationships thereof. The boundaries of these functional building blocks have been arbitrarily defined herein for the convenience of the description. Alternate boundaries may be defined so long as the specified functions and relationships thereof are appropriately performed.

It will be apparent to those skilled in the relevant art(s) that various changes in form and detail can be made therein without departing from the spirit and scope of the disclosure.

What is claimed is:

1. A security monitoring managed access system for managing access to a secure housing facility, the security monitoring managed access system comprising:
a processing system that includes:
an illumination system configured to light an area surrounding the secure housing facility;
a feature capture system configured to capture features of one or more individuals within the lighted area;
a database system that stores information pertaining to unauthorized and authorized individuals, wherein the information comprises facial images; and
a 3-D access module configured to compare the captured media to each of the facial images of the unauthorized and authorized individuals.

2. The security monitoring managed access system of claim 1, wherein the feature capture system further comprises:
an audio engine configured to receive acoustic characteristics from a microphone;
an infrared engine configured to receive thermographic captured media from an infrared camera upon detection of the individuals seeking entry into the secure housing facility; and
a 3-D camera engine configured to receive captured media from a 3-D camera upon detection of the individuals seeking entry into the secure housing facility.

3. The security monitoring managed access system of claim 3, wherein the audio engine is configured to instruct the infrared engine to capture the thermographic captured media using the infrared camera and the 3-D engine to capture media using the 3-D camera of the individuals seeking entry to the secure housing facility upon comparing the received acoustic characteristics to a threshold.

4. The security monitoring managed access system of claim 3, wherein the captured media is at least one of a still image or a recorded video with added depth perception.

5. The security monitoring managed access system of claim 1, wherein the information pertaining to at least one of unauthorized or authorized individuals comprises names of individuals associated with facial images of the individuals and 3-D characteristics of the individual's facial features.

6. The security monitoring managed access system of claim 1, wherein the database system comprises an authorized access database configured to store information pertaining to individuals allowed access into the secure housing facility.

7. The security monitoring managed access system of claim 6, wherein the 3-D access module is configured to compare the captured media to each of the facial images of the unauthorized and authorized individuals using at least one of a facial recognition algorithm and a facial architecture recognition algorithm.

8. A security monitoring managed access system for managing access to a secure housing facility, the security monitoring managed access system comprising:
a sensor gatherer module configured to receive current settings associated with surveillance devices monitoring the individuals seeking entry to the secure housing facility;
an alert engine configured to receive information pertaining to an alert from a 3-D access module based on a result of a facial comparison between captured media;
a logging and recording system configured to monitor and record all activities within the security monitoring managed access system in a log file; and
an authentication module configured to receive at least one of an authentication signal or a non-authentication signal based on the result of the facial comparison.

9. The security monitoring managed access system of claim 8, further comprising a special clearance personnel module configured to receive the information pertaining to the alert upon detection of an unauthorized individual seeking entry to the secure housing facility.

10. The security monitoring managed access system of claim 9, wherein the special clearance personnel module is configured to transmit the information pertaining to the alert to alert supervisors of an intrusion at the secure housing facility.

11. The security monitoring managed access system of claim 8, wherein the logging and recording system is configured to store the activities in the log file with any associated captured media.

12. The security monitoring managed access system of claim 8, wherein the alert engine is configured to transmit the information pertaining to the alert to the special clearance personnel module.

13. The security monitoring managed access system of claim 8, wherein the sensor gatherer module is configured to store the current settings associated with the surveillance devices and receive and store adjustments to the current settings associated with the surveillance devices.

14. The security monitoring managed access system of claim 13, wherein the sensor gatherer module is configured to receive a notification of a triggered detection of movement by one or more of the surveillance devices and associate the notification of the triggered detection of movement with the adjustments to the current settings.

15. The security monitoring managed access system of claim 8, wherein the authentication module transmits a signal to the secure housing facility to lock, unlock, or open a secure housing facility door based on the authentication or the non-authentication signal.

16. A method for managing access to a secure housing facility, the method comprising:
receiving captured media upon detection of an individual seeking access to the secure housing facility;
determining an identification of the individual in captured media by comparing the individual to facial images and 3-D facial characteristics of authorized and unauthorized individuals; and
transmitting a lock, unlock, or open instruction to a secure housing facility door based on the comparing.

17. The method of claim 16, wherein the individual includes a prisoner, a prison staff, or a supervisor.

18. The method of claim 16, wherein the determining the identification of the individual comprises recording a log entry with an associated date, timestamp, current settings of surveillance devices, and captured media.

19. The method of claim 16, wherein the determining the identification of the individual comprises comparing a number of facial features found in the captured media to a threshold.

20. The method of claim 19, wherein the comparing the number of facial features found in the captured media to a threshold comprises generating adjustment data for surveillance devices to recapture media when the number of facial features found does not exceed the threshold.
